(19) United States
(12) Patent Application Publication
(10) Pub. No.: US 2005/0118506 A1
(43) Pub. Date: Jun. 2, 2005

(54) Carbon material for electrodes of lithium-ion power sources and method of production thereof

(76) Inventors: Yury Pustovalov, Marlupol (UA); Elana Shembel, Coral Springs, FL (US); Leon Vishnyakov, Kyiv (UA); Natalia Globa, Dnipropatrovsk (UA); Igor Sagirov, Marlupol (UA); Nellya Zaderey, Dnipropatrovsk (UA); Peter Novak, Fort Lauderdale, FL (US)

Correspondence Address: AKERMAN SENTERFITT, P.O. BOX 3188, WEST PALM BEACH, FL, 33402-3188, US

(21) Appl. No.: 10/898,631

(22) Filed: Jul. 23, 2004

(30) Foreign Application Priority Data
Jul. 25, 2003 (UA) 2003077002

(51) Int. Cl. H01M 4/58; C01B 31/00; C01B 31/02; C01B 31/04

(52) U.S. Cl. 429/231.8; 423/445 R; 423/448

(57) ABSTRACT

A method of producing thermally extended graphite (TEG), includes the steps of receiving of the intercalated graphite mass, heat-treatment with heating using straight electric current, and withdrawal of gaseous reaction products and the repeated treatment of the TEG using straight current in the same reactor.

### FIELD OF INVENTION

Invention relates to carbon materials and technologies of their production, in particular, for further making use of them in as anodes of rechargeable lithium-ion chemical power sources.

### BACKGROUND OF THE INVENTION

There exist porous carbon materials for making anode electrodes of Li-ion battery, produced from polymeric materials by foaming and heating without air access to high temperatures for their base further coking or semicoking, for example patent USA [1]. Electrode material is produced from organic polymer by heating it in inert gas, for example, in argon attached to temperature 500-1500° C., preferably to heat in temperature space from the very beginning of coking to the temperature rate of 300° C. higher.

There also exist a microcellular carbonaceous anode for recharging lithium- ion batteries, in which electrode material is produced from organic polymerized gel, having an open pores structure, which is heated, at first, in oxygen to the temperature rate of 240° C., and after that in inert gas in a way to preserve the produced porous structure, and in the end, it is quenched at the speed not more than 0.50° C./min. [2].

There is a material, which meets the requirements of this invention. This is the material for lithium-ion power sources production, which is produced by means of fluorine chlorine, iodine or phosphorus intercalation, into carbon material with consequent decomposition of the produced compounds at high temperatures (600 1600° C.) [3].

The materials discussed in [1, 2, 3] are produced using complicated technologies of initial materials transformations for mainly in coke. It is known, that in order to receive the maximum discharge capacity, the final voltage of the charge for the cells with negative electrode based on coke base, is usually set at the lower voltage ( 2.5 V), in comparison with negative electrode based on graphite for accumulators (3V). Besides, the lithium-ion secondary battery with negative electrode based on graphite are able to provide a higher load current and lower heating during charge and discharge period, than the cells with negative electrode based on coke.

It is also known, that the ideal anode for lithium-ion chemical power sources, that enable to produce maximum calculation discharge capacity 372 MAh/g., is the compound LiC₆, which can be produced only from highly-ordered graphite with low-defect crystalline structure, for example, on the basis of natural graphite. However, the use of natural graphite when producing anodes for lithium-ion chemical power sources, restrain a lot of problems unsolved, the most essential from which, is the destruction of crystalline grate (graphite matrix) at the expense of deformation of basis layers while receiving LiC₆. This factor causes the abbreviation of maximum permissible amount of charge and discharge battery cycles, that is to diminution of cycling (longevity) of batteries [4].

### SUMMARY OF THE INVENTION

The core of the invention presupposes the production of anode material of lithium-ion rechargeable battery, having a high specific capacity and cycling, low self-discharge, low weight and high reliability.

The target set can be reached in the following way.

The method of carbon material production for electrodes/anode lithium-ion chemical power sources by means of intercalated graphite mass heat treatment in reactor, presupposes (according to the invention) that, the intercalated graphite mass is put to the test of repeated simultaneous heat treatments with current emission directly through intercalated graphite mass with simultaneous emission of gases, created during the first heat treatment period, and the final expansion is carried out during repeated heat treatments in the same reactor.

In place of intercalated graphite mass there is a graphite mass used, which is intercalated in oxidizing medium and irongraphited wastes of metallurgical industry, which are enriched to the ash content rate not more than 10%, and then are intercalated. There is also a natural cryptocrystalline graphite used, which is first enriched, and then is intercalated.

In carbon material, according to the invention, the first intercalated graphite mass heat treatment is carried out at the energy expenditures of 1 kg of oxidized graphite at 0.2-0.6 kW*hour. And the first heating period of each particle of intercalated of graphite mass is carried out from expansion period beginning till final temperature rate with heating duration of 0.01- 3 sec., the repeated graphite heating is carried out with energy expenditures for 1 kg of extended graphite mass 0.2 8 kW/hour, and the time of repeated heating lasts for 1-45 sec. During the process of repeated heating the thermally extended graphite is washed by the gas stream.

Air or inert gas is usually used for washing of extended graphite during the repeated heating.

The method is carried out by means of the following factors.

Heat treatment of the output intercalated graphite mass is carried out in two heating zones.

In the first heating zone there is intercalated compound decomposition reaction into graphite, which leads to the production of thermo-expanded graphite (TEG). It is necessary to purge away the reaction of gas emission from the first heating zone, in order it can not react with hard reaction products or leave a sediment on TEG during the further cooling process.

In the second heating zone the TEG produced during the first zone goes through repeated heat treatment. The repeated heat treatment leads to a) the expansion of those particles of initial intercalated graphite, which did not show chemical reaction during the first zone (decomposition of residual intercalated compounds into graphite) and 6) to the ablation of remainders of gaseous reaction products adsorbed on the surface of TEG. Herewith there are all necessary conditions created for the preparation of crystalline graphite structure for its consequent intercalation of lithium compounds during charge period of lithium-ion chemical power source.

In place of intercalated graphite mass there can be used graphite intercalated compound, which is, for example, an interlayer compound of natural, artificial or synthetic graphite with acid remainders of sulphuric or nitric acid . These interlayer compounds are produced when going through graphite interaction reaction with acid remainder in oxidizing medium. An oxidizing medium can be provided, for example, by nitric acid, potassium chromate, potassium permanganate and etc., which are in the reactor during the process of graphite intercalation. Herewith there are intercalated graphite compounds produced, able to self-extension during the process of heating as a result of intercalant gasification at the rapid heating of intercalated graphite mass. Besides, the crystalline structure of the compounds produced during such graphite intercalated compound preparation period is very close to the crystalline compounds lithium graphite intercalation structure. It was determined, that graphite, which is educed in metallurgical production on cast-iron surface during its gradual cooling in ladle pots and during its pouring into the mixers or which is educed during the cast-iron desulphuration by argon mixture with magnesium, looks like graphite scales, on which iron oxides or iron particles are situated. The latter can be easily removed by chemical acid clearance. The iron admixtures can lead to the defects of crystalline graphite grate, which can be considered as vacancies. Their form and amount ensure to receive compounds of lithium intercalation into graphite during the charge of Li-ion battery

The enriching products of before-named graphite can be used as raw materials to receive intercalated graphite before its heat treatment. This may require preliminary clearance of disperse iron-graphite wastes (DIGW) by means of flotation or by dry methods (magnetic and/or air-, separation, sizing and etc.) with consequent iron dissolution, which remained on particles, in salt acid during boiling period of 1-10 hours.

It is preferably to use a narrow particles faction, which pass through sieve with a cell sizing 160 micron and are remained on the grid 63 sizing micron

Thus, the utilization of metallurgical production wastes, which are exposed to processing using such technology enables to receive a qualitative carbon material for anodes of lithium-ion power sources. Besides, the raw material sources are essentially expanded aiming at TEG structure receiving. The ecological questions, related to metallurgical production wastes processing, are being solved. The use of faction sizing 60-160 mcm is more preferable, than the use of other factions, as far as it allows to receive higher electrochemical indexes (with lower correlation of charge and discharge capacities), as compared with the use of other factions of the same graphite group.

Another initial material—is an enriched cryptocrystalline natural graphite. This graphite usually has a rhombohedrical crystalline grate. Such graphite usually preserves the shape of particles, which is close to spherical or needle-shaped. The use of such graphite for the purpose of production of intercalated graphite mass before its heat treatment enables to receive high electrochemical characteristics of lithium-ion power sources.

Electrochemical electrodes characteristics produced from TEG are considerably higher, than that of the electrodes produced from initial graphite, which is used to produce TEG. For carrying out the heat treatment (decompositions) of intercalated graphite mass it is necessary to expose some energy. For the samples researched the heat treatment consumption of power for 1 kg of final material in first heating zone is limited by 0.2-0.6 kW*hour.

In order to receive the needed graphite characteristics in is necessary to take into account the heating time of each particle of initial material from the temperatures that are lower for graphite expansion beginning till the final temperature in first heating zone. The minimum heating time is reached due to the expansion of graphite in the electrocycle discharge. The electrocycle discharge is produced as a result of gas emission products, as a result of contacts disconnection between graphite particles at the very beginning of compound decomposition of intercalation into graphite and their transformation into TEG. The electro cycle discharge heats not only the particles, between which a voltaic arc was developed, but also the neighboring particles.

In case of absence of considerable graphite expansion during its heating the electric arcs are less intensive and particles heating time can be increased to 3 seconds.

In order to achieve such product descriptions it is necessary, that a repeated heating takes sufficient energy and time expenditures, to achieve and maintain high temperatures and full decomposition of residual compounds of intercalation into graphite and full graphite expansion.

For prevention of sedimentation of gaseous reaction products on surface of hard product it is necessary to create the conditions, according to which a cooling process of hard reaction (extended graphite) product is carried out in gas medium, containing no gaseous reaction products. For that purpose it is necessary to put gas into repeated heating zone. This gas proves not to be harmful on the surface of extended graphite. The examples of such gases can be, air, inert gas (argon, nitrogen), gases reducers.

For the same aim the creation of zone rarefaction can be used, where gaseous reaction products are disposed; as a result air or another gas is drawn into the zone of repeated heating.

The process of extended graphite production is performed in the following way.

The intercalated graphite mass produced by using all possible methods is washed away of acid and other admixtures and is dried out.

The intercalated graphite mass is added gradually or propitiously into the heat treatment block, by means weigher. The electric current is transmitted, which heats the material, while passing over it. That leads to thermal material expansion which is emerged in the reaction zone of electro cycle discharge. The Gaseous reaction products are set aside, and the extended graphite moves in another direction; it gets the second heating zone, where it is repeatedly heated by means of passing the electric current through it.

In case of discrete initial material supply the shift of hard material is not obligatory, and a role of second the heating zone is played by the first heating zone after withdrawal of gaseous reaction products.

The second heating zone is added by gaseous substance to withdraw gaseous reaction products from the zone of reaction.

From second heating zone the hard reaction product is added into receiving bin.

We will prove that in the following examples.

### EXAMPLE 1

The DIGW of mixing device of metallurgical enterprise, are cleared from iron by method of magnetic separation. The fraction 63-315 mcm was received by means of sizing. The ash rate of such powder is 10%.

The 0.1 kg weight of the received powder is mixed with 0.0125 kg of biopotassium and with 0.5 kg of saturated sulphuric acid. This mixing process lasts for 10 minutes. Then, this powder is diluted by the mixture of water and is stood in the produced solution of sulphuric acid for 1 hour for withdrawal of iron compounds, (iron and its oxides are better interacted with diluted sulphuric acid, that's why withdrawal takes little time), and washed by means of decantation. After that the oxidized graphite (OG) produced is replaced to the vacuum filter, is washed till the neutral reaction of washing waters, is dehydrated at the vacuum filter till humidity rate of 15-40%, after that is dried at high temperature till humidity rate of 1%. The Oxidized graphite looks like graphite interlayer compound with remainders of sulphuric acid and water, which are between base graphite layers.

OG is placed into the sizing bin for thermal graphite expansion.

The OG heating, which is placed into reactionary device zone, is carried out at electro cycle discharge. Herewith the particles heating is carried out till the working temperature (1000° C. and higher) during the period of time, not exceeding 1 second. The temperature is received by required energy expenditures at the expense of reactor construction and power source.

The gases produced during reaction (the compounds of sulphur at different oxidation degrees from −2 to +6 depending on temperature and heating time) are withdrawn from the heating zone, the material is transferred to the calcinations zone of the working bin, where TEG is heated till the temperature rate is 900° C. during the period of time −3-5 seconds and then is set to the receiving bin.

| TEG receiving process descriptions. | |
|---|---|
| Electric power expenditures in first heating zone, kW-h/kg IGM | 0.25 |
| Electric power Expenditures in second heating zone, kW-h/kg TEG | 0.5 |
| TEG physical and chemical descriptions | |
| TEG bulk weight kg/m³ | 6.2 |
| TEG ash rate, % | 5.3 |

From the TEG produced there are electrodes compressed and are determined electrochemical descriptions of the material produced by means of the following methods.

An electrode on base TEG is placed into three-electrode device. The role of auxiliary electrode and comparison electrode is played by metallic lithium. In the place of electrolyte the solution of lithium salt is used in nonaqueous aprotic solvent.

| TEG electrochemical descriptions | |
|---|---|
| Charge capacity of first cycle, mAh/g | 476 |
| Discharge capacity of first cycle, mAh/g | 210 |
| Capacities correlation charge/discharge, mAh/g | 2.27 |

### EXAMPLE 2

DIGW desulpharation compartment of metallurgical enterprise is cleared from iron by the method of magnetic separation and air-separation, by means of sizing the faction 63-160 mcm is drawn. There is a powder produced with ash rate of 9.8%

Oxidation, washing, drying and powder reactor is carried out in the same way as in example 1.

A IGM Heating at straight current is carried out at electro cycle discharge, which is produced during this period. Particles heating is carried out till the working temperature comes to (1000° C. and higher) and lasts for 0.01 seconds.

Gases which are produced during reactions are replaced from the heating zone. After that, the material is transferred to the calcinations zone, where TEG (at the temperature rate of 900° C., during the period of time −3-6 sec.) is cleaned of wastes of adsorbed gaseous reaction products,

| TEG physical and chemical descriptions | |
|---|---|
| TEG bulk weight, kg/m³ | 9.0 |

From the TEG produced there are electrodes compressed and are determined electrochemical descriptions of the material produced by means of the following methods.

| TEG electrochemical descriptions | |
|---|---|
| Charge capacity of the first cycle, mAh/g | 445 |
| Discharge capacity of the first cycle, mAh/g | 263 |
| Capacities correlation charge/discharge, mAh/g | 1.69 |

These and other examples of realization of technical salvation are given in the table.

| No II/II | 1. | 2. | 3. | 4. | 5. |
|---|---|---|---|---|---|
| Initial raw materials | Mixing DIGW | | DIGW of desulpharation | | |
| Fraction, mcm | 65-315 | 65-315 | 63-160 | 63-315 | 63-315 |
| HCl treatment, hour | 6 | 6 | | 5 | 5 |
| H₂SO₄ stand | 0.5 | 0.5 | 0.5 | 0.1 | 0.1 |
| after oxidation, hour | | | | | |
| Temperature in the | Higher than 1000 | | Higher than 1000 | | |
| expansion zone, ° C. | | | | | |
| Temperature in the | 800 | 800 | 900 | 950 | 1000 |
| zone of repeated | | | | | |
| heating, ° C. | | | | | |
| Time of repeated | 3-5 | 3-5 | 10 | 10 | 10 |
| heating, sec | | | | | |
| TEG bulk weight, kg/m³ | 6.2 | 6.2 | 9.0 | 9.0 | 9.8 |
| TEG ash content in, % | 5.3 | 5.3 | 4.8 | 1.5 | 1.4 |
| Charge capacity of | 476 | 646 | 445 | 615 | 598 |
| the first cycle, mAh/g | | | | | |
| Discharge capacity | 210 | 270 | 263 | 283 | 276 |
| of the first cycle, mAh/g | | | | | |
| Capacities correlation | 2.27 | 2.39 | 1.69 | 2.19 | 2.17 |
| charge/discharge, | | | | | |
| mAh/g | | | | | |

### EXAMPLE 3

In the place of initial raw material there is a natural cryptochrystallic graphite used (produced in India).

Graphite is mixed with 0.125 kg of biopotassium and 5 kg saturated sulphuric acid, is stood, while being mixed for 10 minutes, this mixture is diluted by water, and the produced intercalated graphite mass (IGM) is replaced on vacuum filter, where it is washed till the neutral reaction of washing waters, it is dehydrated and dried till the granular condition (humidity by 1%).

Dried IGM is placed into the auger dozer from which the IGM through the quartz pipe is given to the reactionary zone with expense of 5 kg/hour. IGM locks an electric contact between electrodes and gets heated. Having been heated above decomposition beginning point of flaky compound, graphite begins to expand and to exude gaseous reaction products. The Contacts between particles are disturbed, and in contacts breaks places appears voltaic arc, in which the processes are sharply intensified. The Gaseous and hard products of reaction move in different directions. The new portions of IGM set into reactor are replaced, the TEG produced is set to the zone of repeated heating. The repeatedly heat-treated in second heating zone TEG is replaced by the by next portions of TEG from the reactor the receiving bin.

The expense of IGM set into reactor is determined till the beginning of the experiment. The TEG timing is determined by selecting and weighing of TEG, which is set into receiving bin taking a definite period of time.

During the experiment the voltage and capacity of current in each reactor zone is measured, and according to data received the amount of energy is calculated, expended in each heating zone. The bulk weight of the produced material, the product mass is determined, produced at the certain period of time.

### TEG Production Process Descriptions

Electric power expenditures in the first heating zone, kW-h/kg IGM—0.5

Electric power expenditures in the second heating zone, kW-h/kg TEG—1.5

Oxidation, washing, drying and powder reactor is carried out in the same way as in example 1.

The OG heating process is carried out at the straight electric current feed through the powder. Herewith the particles heating till the working temperature (1000° C. and higher) is reached taking 2-3 seconds.

Gases which are produced during reactions are replaced from the heating zone. After that, the material is transferred to the calcinations zone, where TEG (at the temperature rate of 900-1500° C., during the period of time −10-15 sec.) is cleaned of wastes of adsorbed gaseous reaction products

| TEG physical and chemical descriptions | |
|---|---|
| TEG bulk weight, kg/M3 | 180.0 |

From the received TEG the electrodes were produced and the electrochemical descriptions of the received material were defined using methods, described in example 1.

| TEG electrochemical descriptions | |
|---|---|
| Charging capacity of the first cycle, mAh/g | 460 |
| Discharging capacity of the first cycle, mAh/g | 245 |
| Capacities correlation charge/discharge, mAh/g | 1.88 |

As it is seen from given results, the method offered allows to receive a high-quality material for electrodes for lithium-ionic chemical current sources.

### REFERENCES CITED

1. U.S. Pat. No. 5,510,212 Delnick, and oth. from Apr. 23, 1996.

2. Carbonaceous material and its production methods. U.S. Pat. No. 5,591,545 Miyashita, and oth. dating 7 Jan. 1997.

3. U.S. Pat. No. 5,985,489 Ohsaki and oth., dating 16 Nov. 1999.

4. A. Fialkov., Carbon, and its interlaminar connections and compounds.—M.: Aspect Progress, 1997. page 330.

1. Method of getting carbon material for electrodes of lithium-ionic current sources by means of graphite intercalated mass heat treatment in reactor. It is peculiar for this method that, the intercalated graphite mass is put to the test of repeated simultaneous heat treatments with current emission directly through intercalated graphite mass with simultaneous emission of gases, created during the first heat treatment period, but the final expansion is carried out during repeated heat treatments in the same reactor.

2. Method according to claim 1. It is peculiar that, in place of intercalated graphite mass there is a graphite mass used, which is intercalated in oxidizing medium.

3. Method according to claim 1. It is peculiar that in place of intercalated graphite mass there are disperse iron-graphite wastes of metallurgical industry used, which are enriched till the ash rate no more than of 10% and then are intercalated.

4. Method according to claim 1. It is peculiar that in place of intercalated graphite mass there is a natural cryptocrystallic graphite used, which is enriched and then, intercalated.

5. Method according to claim 1. It is peculiar that the first heating of intercalated graphite mass is carried out at energy expenditure of 1 kg of oxidized graphite 0.2-0.6 kWh.

6. Method according to claim 1. It is peculiar that, the first heating period of each particle of intercalated of graphite mass is carried out from expansion period beginning till the final temperature rate with heating duration of 0.01 3 sec.

7. Method according to claim 1. It is peculiar that the repeated graphite heating is carried out with energy expenditures for 1 kg of extended graphite mass 0.2 8 kWh, and the time of repeated heating lasts for 1-45 sec.

8. Method according to claim 1. It is peculiar that during the process of repeated heating the thermally extended graphite is washed by the gas stream.

9. Method according to claim 1. It is peculiar that for washing of extended graphite during the repeated heating—air is used.

10. Method according to claim 1. It is peculiar that for washing of extended graphite during the repeated heating—inert gas is used.
